(19) United States
(12) Patent Application Publication
(10) Pub. No.: US 2010/0242742 A1
(43) Pub. Date: Sep. 30, 2010

(54) Barbecue skewer with multiple prongs

(76) Inventor: Eric Y. Teng, Gold River, CA (US)

Correspondence Address: Eric Y. Teng, 12089 Gold Pointe Lane, Gold River, CA, 95670, US

(21) Appl. No.: 12/661,796

(22) Filed: Mar. 23, 2010

Related U.S. Application Data
(60) Provisional application No. 61/210,963, filed on Mar. 25, 2009.

(51) Int. Cl. A47J 43/18

(52) U.S. Cl. 99/421 A

(57) ABSTRACT

This invention presents a unique barbecue skewer with multiple prongs that branch from a central spine akin to a tree or a fishbone. This simple design transforms the traditional pin-shaped skewer into one that prevents food pieces from self-rotating during grilling. It also allows food pieces to be attached or removed in any order, properly spaces the food pieces apart thus eliminating cold spots, and enables food pieces having different cooking times to be grilled together.

### CROSS-REFERENCE TO RELATED APPLICATIONS

This application claims the benefit of provisional application 61-210963 filed Mar. 25, 2009 by the present inventor.

### BACKGROUND

1. Field of Invention

This invention relates to barbecue tools, specifically a barbecue skewer for use in the grilling of meat, vegetable and fruit pieces.

2. Description of Prior Art

For the purpose of the content of this application including the claims, the term “food piece(s)” is defined to mean meat, vegetable, and/or fruit piece(s).

Traditional barbecue skewers or shish-kebob skewers are generally of a pin-shaped single prong design having a sharp distal end, an elongated body with a circular, oval, square, or rectangular cross-section and a blunt proximal end. During use, individual food pieces are pierced through the sharp end, then pushed down the elongated body until a certain number of food pieces are strung together a few inches above the blunt proximal end. The proximal end without the food pieces is used as a handle allowing a user to pick up the loaded skewer for grilling the food pieces together.

In this traditional design, it can be seen that when the skewer is turned over by the user in an attempt to cook both sides of the loaded skewer, the food pieces would have a tendency to self-rotate by gravitational force. As a result, only one side of the food pieces would be properly grilled leaving the other side still uncooked. This happens because the food pieces are held in place essentially only by the small frictional force between the food pieces and the skewer which can be easily overcome by the gravitational force exerted on the food pieces.

For the purpose of preventing food rotation during grilling, there also exists on the market skewers of a parallel prong design similar to a two-pronged fork with two very long straight prongs that are very close to each other. Food pieces are then pierced by the two sharp ends on the prongs and strung onto the long prongs for grilling. Food pieces held in this manner would not be able to self-rotate by gravity when the skewer is being turned. So the food pieces can be easily cooked evenly on both sides.

However, in preventing food from self-rotating, this design has introduced another disadvantage which is that such that two holes instead of one have to be pierced into the food, thereby causing more food juices to flow out and be lost during grilling.

It should be noted here that almost all the traditional skewer are made either of bamboo, wood, or metal. The bamboo or wooden skewers are basically for one-time use while the metal skewers can be used for an indefinite number of times. A fundamental characteristic of traditional skewers whether the single or dual-prongs design, is that the food pieces must be removed in the exact reverse order that they were strung together thus limiting their flexibility in usage. Additionally, since the food pieces are strung together, it is often difficult for users to properly space all the food pieces apart to creating “cold spots” in between the pieces. Such cold spots tend to prevent food pieces from being properly cooked causing a potential health hazard.

### OBJECTS AND ADVANTAGES

The objects and advantages of the present invention are:
a) to provide a handy and compact skewer for use in grilling that can accommodate a varying amount of food pieces from several to a few dozen;
b) to provide a skewer whereby food items with different cooking rates may be grilled together;
c) to provide a skewer whereby a user can attach or remove any food piece in any preferred order;
d) to provide a skewer whereby food would not self-rotate with the turning of the skewer during grilling;
e) to provide a skewer that allows even spacing between the food pieces eliminating ‘cold spots” that may cause safety hazard;
f) to provide an aesthetically attractive novel skewer that would serve as a conversation piece during a barbecue social gathering event.

Still further objects and advantages will become apparent from a consideration of the ensuing descriptions and drawings.

### SUMMARY

In accordance with the present invention a barbecue skewer with a handle, a main spine in the grilling section, and multiple prongs that branch off of the main spine in the fashion of a tree or fishbone.

### DRAWINGS

FIG. 1 Preferred Embodiment—Skewer with a zigzaged main spine

FIG. 2 Skewer having a straight main spine

### REFERENCE NUMERALS

100 Fore or grilling section of the skewer
101 to 108 Side (grilling) prongs
110 End or tip (grilling) prong
150 Central or Main spine in grilling section
200 Handle section
201 Handle
202 Flat Handle Grip

### DETAILED DESCRIPTION

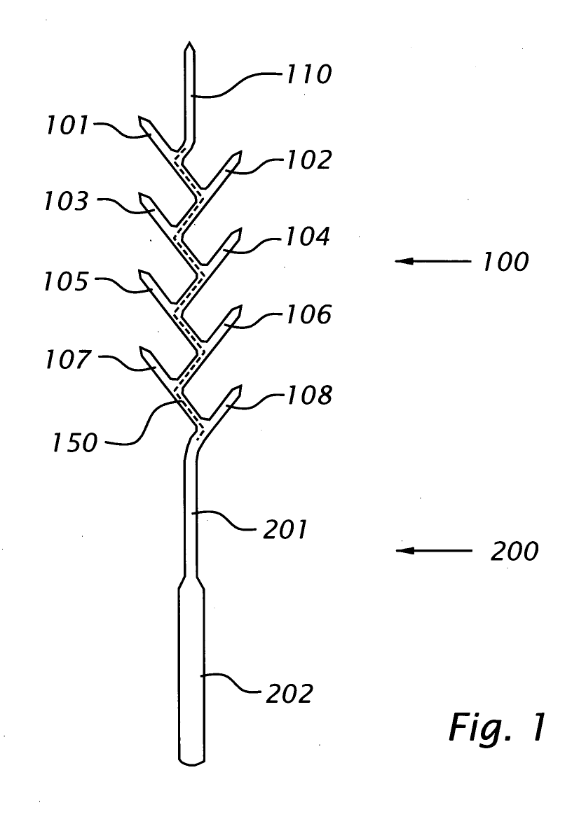

### FIG. 1 Preferred Embodiment

Referring to FIG. 1 which shows the preferred embodiment of this invention: the skewer can be seen to have a fore or grilling section 100 comprising of a central or main spine 150 that extends the full length of the grilling section in a zigzag fashion, a number of grilling side prongs 101-108 that branch out from the main spine, and an end or tip prong 110 at the very end of the grilling section. This grilling section adjoins an elongated handle 201 ending with a flat portion of the handle serving as a comfortable hand grip 202.

For better balance and to prevent the food pieces from falling off when the skewer is held up by a user's hand, the prongs are shown to be pointing upwards away from the handle.

A skewer of this design can be produced by two different methods:

The first method is by cutting the skewer directly from a metal sheet of an appropriate thickness. This can be accomplished by either laser cutting or water jet cutting. Then the tip of each prong can be appropriately sharpened to enable easy piercing of individual food pieces, but not so sharp that the points of the prongs become dangerous for a user to handle. The skewers thus produced generally are characterized by having a rectangular cross-section and a flat hand-grip towards the proximal or handle end.

Another method of producing the same skewer is by first cutting an elongated thin metal rod material into separate prongs 101 through 110, and a long handle 201. Then all the pieces are welded together with the prongs joining each other in a T-joint forming the grilling section 100, which is welded onto one end of the handle 201. A separate hand grip of a heat insulating material such as wood can be added to the proximal end of the handle for comfort and heat insulation. The ends of the prongs should be sharpened either before or after the entire skewer is welded. The skewer thus produced is generally characterized by having noticeable welding joints at each T-joint and the prongs can have a round, oval, square or rectangular cross-section depending on the rod metal material used.

One way to view the structure shown in FIG. 1 is that there is a zigzag main spine 150 that spans the entire length of the fore or grilling section 100 of the skewer. This main spine 150 is shown to have a number of side prong 101-108 that branch away from it in an upward angle with an end prong 110 located at its tip. The handle section 200 is shown to be straight and without any prongs. A flat hand grip 202 (or alternatively a hand grip with heat insulating material) is shown at the very end of the handle for comfortable hand-holding.

During use, each individual food piece can be pierced to an individual prong. Then the loaded set can be grilled together. If the length of each prong is short as shown in the drawing, then each prong can only accommodate one food piece. Longer prongs can be used to accommodate multiple food pieces.

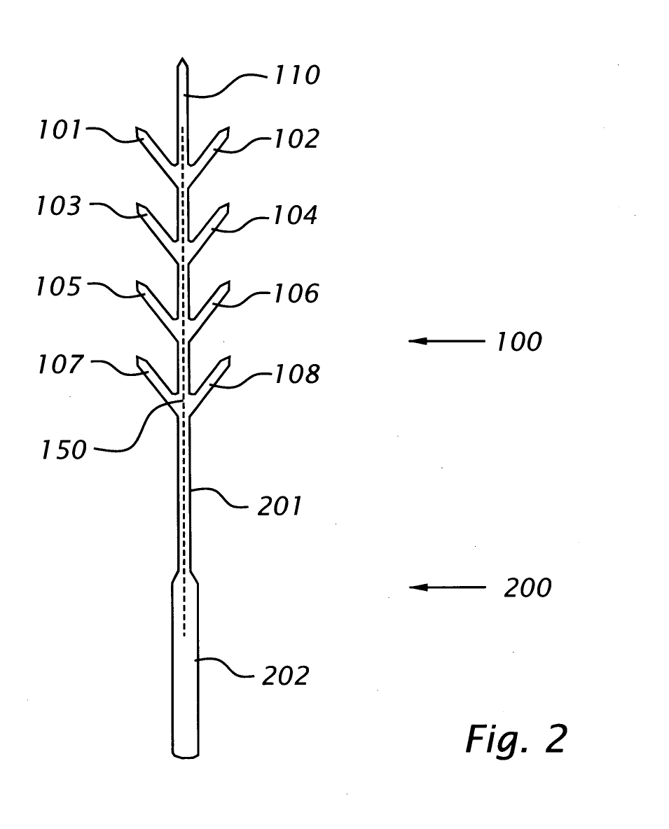

The advantages of a skewer of this design are:
1) Food pieces with different cooking rates can all be cooked together. For example, the mushroom with a longer cooking time can first be pierced onto the skewer and be grilled first. Then once it is half-cooked, the steak with a shorter cooking time can be added onto the skewer and be grilled together with the half-cooked mushroom. Then the whole set can finish grilling at the same time with both the mushroom and steak properly cooked.
2) Food pieces can be easily accessed in any order. After the loaded skewer is properly grilled, one can elect to serve, say, the chicken first, then the mushroom, then the steak. This can be compared to using the traditional skewer where the user is restricted to serving the food in the exact reverse order as when the food pieces were first strung onto the skewer.
3) It can be seen that the food pieces are prevented from self-rotating by the neighboring prongs and the main spine once they are pierced onto the prongs and pushed down towards the end of each prong. Thus a user can easily flip the skewer to allow both sides of the food pieces to be cooked evenly.
4) If only one food piece is pierced onto each prong, proper spacing between food pieces would be ensured eliminating any chance of “cold spots” formed in the traditional pin-shaped skewer when the pieces are packed too tightly together. The cold spots can prevent some parts of raw meat pieces to not be properly cooked increasing the likelihood of food poisoning.
5) FIGS. 1 and 2 depict skewers with only short prongs suitable for piecing only one food piece onto them. However, the prongs can also be lengthened so as to allow multiple food pieces to be strung together on each prong. A skewer with this design would allow each skewer to accommodate many more food pieces. With suitably long prongs, one skewer can be used to grill food pieces sufficient to feed several people at once.

FIG. 2 shows a skewer of a slightly different design. This has a straight main spine 150 throughout its entire length spanning both the grilling and the handle sections. For a skewer of this design to be produced by welding, each individual prong will be welded onto the long main spine forming the fore-grilling section, and not onto each other as the skewer shown in FIG. 1.

A skewer of this invention can have very different total lengths depending on its purpose. For example, a skewer made for indoor grilling can be as short as less than 10 inches. On the other hand, a skewer made for grilling over a camp fire can be longer than 3 or 4 feet. For general barbecuing over a grill, the skewer should have a length between 12 to 24 inches with 18 inches as a standard. The individual prongs should be about 1½ inch for accommodating one food piece, and be from 3 to 10 inches to accommodate multiple food pieces.

What is claimed is:

1) A grilling implement comprising a fore grilling section and a rear elongated handle means; said grilling section comprising an elongated central spine that spans the entire length of said grilling section; said central spine having a plurality of spaced apart prongs that branch away from said central spine; said prongs having pointed tips suitable for piercing and attachment of food pieces; said central spine adjoins said elongated handle means; whereby food pieces can be skewed onto said prongs for grilling.

2) Grilling implement of claim 1, further including a tip prong disposed at the fore-end of said grilling section.

3) Grilling implement of claim 1, said prongs are of a predetermined length sufficient for accommodating one individual food piece on each said prong.

4) Grilling implement of claim 1, said prongs are of a predetermined length sufficient for accommodating a plurality of food pieces on each said prong.

5) Grilling implement of claim 1, said prongs are disposed in a direction pointing upwards away from said handle means when said skewer is held in an upward direction.

6) Grilling implement of claim 1, said central spine is disposed in a zigzag fashion in said grilling section.

7) Grilling implement of claim 1, said central spine is straight throughout its entire length.
